(19) United States
(12) Patent Application Publication
(10) Pub. No.: US 2026/0208605 A1
(43) Pub. Date: Jul. 23, 2026

(54) ELECTRIC VEHICLE CHARGING DEVICE EQUIPPED WITH HOLDER AND ELECTRIC VEHICLE AUTOMATIC CHARGING SYSTEM INCLUDING THE SAME

(71) Applicants: Hyundai Motor Company, Seoul (KR); Kia Corporation, Seoul (KR)

(72) Inventors: Yong Chul SHIN, Hwaseong-si (KR); Ki Hoon NAM, Hwaseong-si (KR); Youn LEE, Hwaseong-si (KR); Byung Ho YOON, Hwaseong-si (KR); Keon Woo KANG, Hwaseong-si (KR)

(21) Appl. No.: 19/242,113

(22) Filed: Jun. 18, 2025

(30) Foreign Application Priority Data
Jan. 21, 2025 (KR) 10-2025-0009072

(51) Int. Cl. B60L 53/16; B60L 53/35; H01R 13/627

(52) U.S. Cl. CPC B60L 53/16; B60L 53/35; H01R 13/6272

(57) ABSTRACT

An electric vehicle charging device includes a charging connector configured to be connected to a charging terminal of an electric vehicle, and a holder configured to mount the charging connector. The holder includes a support, a slide coupled to the support and configured to move relative to the support in an upward/downward direction, and an elastic part that connects the slide to the support in the upward/downward direction. The slide includes a first roller and a second roller that are configured to rotate, based on the charging connector being inserted to or withdrawn from the holder, contact an outer surface of the charging connector and rotate along the outer surface of the charging connector. The first and second rollers are configured to be positioned at symmetric positions with respect to the charging connector.

### CROSS-REFERENCE TO RELATED APPLICATION

This application claims priority to and the benefit of Korean Patent Application No. 10-2025-0009072, filed in the Korean Intellectual Property Office on Jan. 21, 2025, the entire contents of which are incorporated herein by reference.

### TECHNICAL FIELD

The present disclosure relates to an electric vehicle charging device equipped with a holder and an electric vehicle automatic charging system including the same.

### BACKGROUND

Electric vehicles may reduce environmental pollution and provide sustainable energy consumption. In some cases, electric vehicles may use various charging technologies and charging devices.

For example, electric vehicle charging devices may connect or disconnect charging connectors manually, which may cause inconveniences to users. In some cases, an automatic charging system may charge an electric vehicle in an unmanned manner by using a charging robot.

In some cases, a position of the charging connector may not be constant during a process in which the charging robot separates a charging connector from a holder or mounts the charging connector to the holder again. In some cases, an operation of grasping the charging connector may not be stable because the charging connector is rotated or moved when the charging robot grasps the charging connector.

### SUMMARY

The present disclosure describes an electric vehicle charging device equipped with a holder, the electric vehicle charging device being capable of preventing a rotation of a charging connector, and an electric vehicle automatic charging system including the same.

According to one aspect of the subject matter described in this application, an electric vehicle charging device includes a charging connector configured to be connected to a charging terminal of an electric vehicle, and a holder configured to mount the charging connector. The holder includes a support, a slide coupled to the support and configured to move relative to the support in an upward/downward direction, and an elastic part that connects the slide to the support in the upward/downward direction. The slide includes a first roller and a second roller that are configured to, based on the charging connector being inserted to or withdrawn from the holder, contact an outer surface of the charging connector and rotate along the outer surface of the charging connector, where the first and second rollers are configured to be positioned at symmetric positions with respect to the charging connector.

Implementations according to this aspect can include one or more of the following features. For example, the first roller can be configured to rotate about a first rotation axis inclined by a first predetermined angle with respect to the upward/downward direction, and the second roller can be configured to rotate about a second rotation axis inclined by a second predetermined angle with respect to the upward/downward direction.

In some examples, the slide can further include a slide body to which the first and second rollers are rotatably coupled in a state in which the first and second rollers are inclined with respect to the upward/downward direction, where the first and second rotation axes become closer to each other as the first and second rotation axes extend upward toward the slide body. In some examples, the slide can further include a third roller coupled to the slide body and configured to rotate about a third rotation axis, the third rotation axis extending in a leftward/rightward direction orthogonal to the upward/downward direction. For example, the third roller can be positioned above the first roller and the second roller.

In some implementations, the electric vehicle charging device can include a main body coupled to the holder and configured to control operation of the electric vehicle charging device, where the holder is configured to receive the charging connector along a reference direction, and a surface of the support is fixed to the main body in the reference direction.

In some implementations, the slide body can include a base portion, a first roller coupling portion that extends downward from a first side of the base portion, a second roller coupling portion that extends downward from a second side of the base portion, and a third roller coupling portion that is disposed between the first roller coupling portion and the second roller coupling portion and that extends from the base portion in a direction opposite to the reference direction. In some examples, the first predetermined angle is defined between the first rotation axis and a first imaginary straight line extending through the first roller in the upward/downward direction, and the second predetermined angle is defined between the second rotation axis and a second imaginary straight line passing through the second roller in the upward/downward direction, where the first and second rotation axes are symmetric with respect to a plane extending through the holder in the upward/downward direction.

In some implementations, the support comprises a stopper configured to come into contact with the slide and to restrict a downward movement of the slide. In some implementations, the support can further include a slide protrusion that extends in the upward/downward direction and is configured to movably couple the slide to the support, where the slide defines a slide groove configured to receive the slide protrusion.

In some implementations, the elastic part can be configured to, based on the slide being raised by charging connector, generate restoring force while being stretched by a predetermined length, and apply the restoring force to the slider to thereby provide pulling force to the slide downward. For examples, the elastic part can include a spring.

In some implementations, the charging connector can include a connector main body including a charging robot coupling part, one or more charging protrusions that protrude from the connector main body, and a latch coupled to the connector main body and positioned above the one or more charging protrusions. In some examples, the holder can further include a connector fixing part including a socket configured to receive the one or more charging protrusions, and a fixing protrusion that protrudes from an upper side of the socket and is configured to catch and couple to the latch.

In some implementations, the latch can be configured to, based on the charging connector being mounted to the holder, be fixed to the fixing protrusion by being caught by the fixing protrusion, where the first and second rollers are configured to press the charging connector by restoring force of the elastic part.

According to another aspect, an electric vehicle automatic charging system includes an electric vehicle charging device including a charging connector configured to be connected to a charging terminal of an electric vehicle, and a charging machine configured to grasp the charging connector, the charging machine being configured to at least one of (i) connect the charging connector to the charging terminal of the electric vehicle or (ii) separate the charging connector from the charging terminal of the electric vehicle. The electric vehicle charging device further includes a holder configured to mount the charging connector. The holder includes a support, a slide coupled to the support and configured to move relative to the support in an upward/downward direction, and an elastic part that connects the slide to the support in the upward/downward direction. The slide includes a first roller and a second roller that are configured to, based on the charging connector being inserted to or withdrawn from the holder, contact an outer surface of the charging connector and rotate along the outer surface of the charging connector. The first and second rollers are configured to be positioned at symmetric positions with respect to the charging connector.

Implementations according to this aspect can include one or more of the following features or the features described above with respect to the electric vehicle charging device. For example, the electric vehicle charging device can further include a main body coupled to the holder and configured to control operation of the electric vehicle charging device.

In some implementations, it can be possible to prevent a rotation and an inadvertent movement of the charging connector mounted in the holder.

In some implementations, the charging connector can be positioned at one position even though a load is applied to the charging connector during the process in which the charging robot grasps the charging connector, such that the charging robot can be stably coupled and separated.

### BRIEF DESCRIPTION OF THE DRAWINGS

FIG. 1 is a view illustrating an example of an electric vehicle charging device.

FIG. 2 is a view illustrating an example of a charging connector of the electric vehicle charging device.

FIG. 3 is a view illustrating an example of a holder of the electric vehicle charging device.

FIG. 4 is a view illustrating an example of a connector fixing part of the electric vehicle charging device.

FIG. 5 is a view illustrating an example operation of mounting the charging connector in the holder in the electric vehicle charging device.

FIG. 6 is a view illustrating an example operation of fixing a latch of the charging connector to the connector fixing part during the operation illustrated in FIG. 5.

FIG. 7 is a view illustrating an example state in which the charging connector is mounted in the holder in the electric vehicle charging device.

FIG. 8 is a view illustrating an example state in which the charging connector is mounted in the holder in the electric vehicle charging device.

FIG. 9 is a block diagram illustrating an example of an electric vehicle automatic charging system including the electric vehicle charging device.

### DETAILED DESCRIPTION

Hereinafter, some embodiments of the present disclosure will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of the embodiments of the present disclosure, a detailed description of related publicly-known configurations or functions will be omitted when it is determined that the detailed description obscures the understanding of the embodiments of the present disclosure.

In the present specification, a leftward/rightward direction and an upward/downward direction are defined for convenience of description and can be orthogonal to one another. These directions are defined relative to directions in which components of an electric vehicle charging device are arranged. In some examples, the upward/downward direction may not mean a vertical direction.

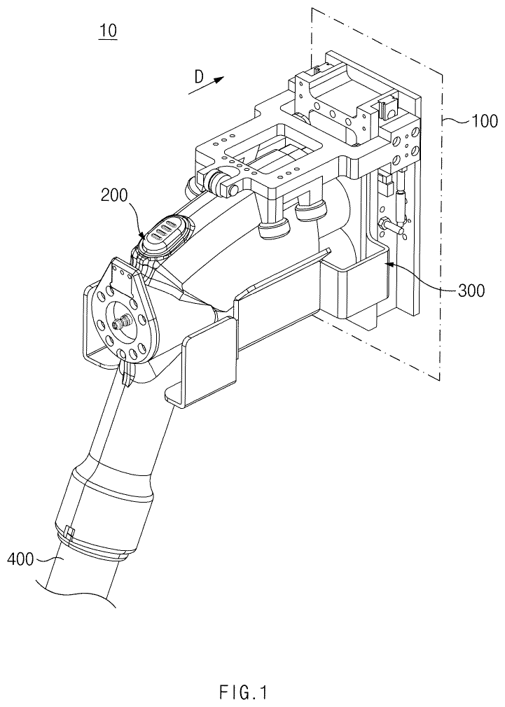

FIG. 1 is a view illustrating an example of an electric vehicle charging device.

An electric vehicle charging device 10 can be a device configured to be coupled to a charging terminal provided in an electric vehicle to charge a battery of the electric vehicle.

In some implementations, with reference to FIG. 1, the electric vehicle charging device 10 can include a main body 100, a charging connector 200, a holder 300, and a cable 400.

The main body 100 can control an overall operation of the electric vehicle charging device 10. The main body 100 can be connected to the charging connector 200 by the cable 400. For example, the main body 100 can be a charging station or charging controller configured to control a process of charging the electric vehicle by the electric vehicle charging device 10. Constituent elements for charging the electric vehicle can be disposed in the main body 100. FIG. 1 is a view schematically illustrating the main body 100.

The charging connector 200 can be connected to the main body 100 by the cable 400. The charging connector 200 can be connected to the charging terminal of the electric vehicle and provide the battery of the electric vehicle with electric power supplied from the main body 100. For example, the charging connector 200 can refer to a charging plug or charging coupler. The charging connector 200 can be separated from the holder 300 during the process of charging the electric vehicle. The charging connector 200 can be mounted in the holder 300 in case that the electric vehicle is on standby after being completely charged.

The holder 300 can be coupled to at least a part of the main body 100. For example, the holder 300 can be fixed to the main body 100 so that the charging connector 200 can be mounted and stored in the holder 300. In some implementations, the holder 300 can be provided such that at least a part of the holder 300 is integrated with the main body 100. That is, the holder 300 can be configured as a part of the main body 100.

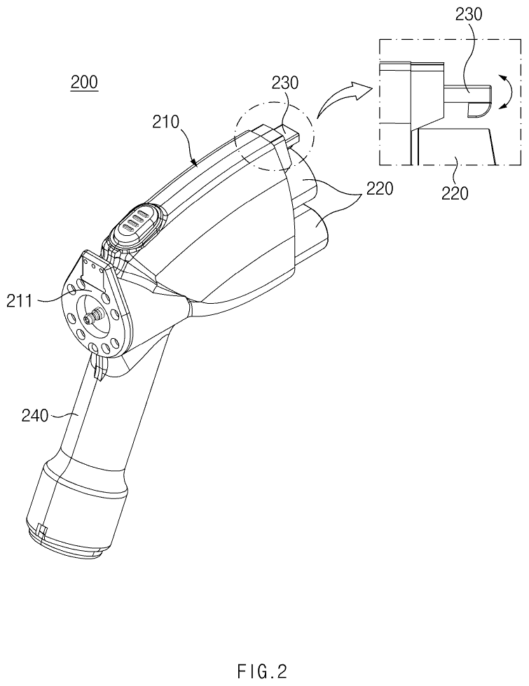

The cable 400 can connect the main body 100 and the charging connector 200 and transmit electric power, which is supplied from the main body 100, to the charging connector 200. The cable 400 can be connected to the charging connector 200. At least a part of the cable 400 can extend to the inside of the charging connector 200 and be connected to a terminal provided on a charging protrusion (e.g., a charging protrusion 220 in FIG. 2) of the charging connector 200.

In the electric vehicle charging device 10, the holder 300 is provided to support the charging connector 200 so that the charging connector 200 is not rotated, such that it is possible to provide a function of disposing the charging connector 200 at a predetermined position with respect to the holder 300 in case that the charging connector 200 is mounted in the holder 300. Hereinafter, constituent elements of the holder 300 and the charging connector 200, which serve to implement the above-mentioned configuration, will be described with reference to FIGS. 2 to 4.

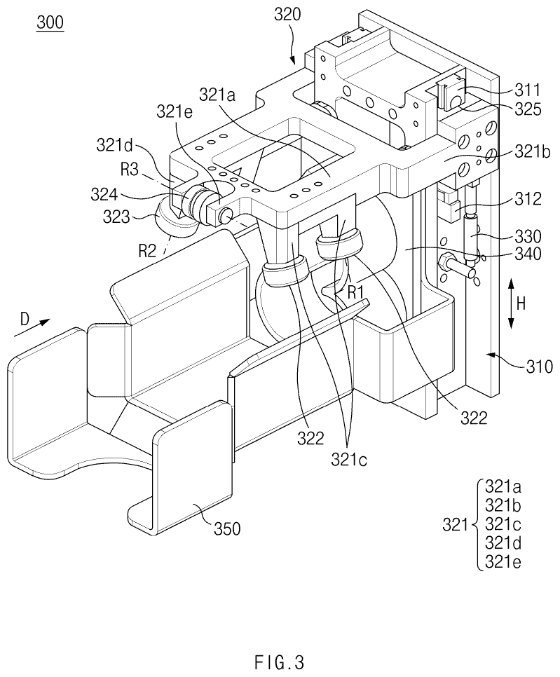

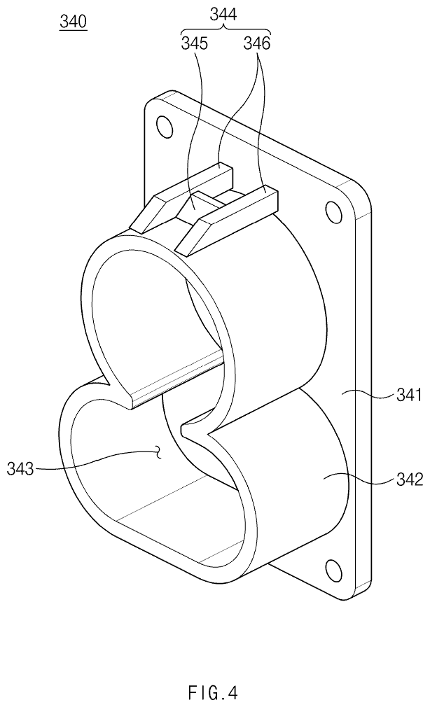

FIG. 2 is a view illustrating the charging connector of the electric vehicle charging device. FIG. 3 is a view illustrating the holder of the electric vehicle charging device. FIG. 4 is a view illustrating a connector fixing part of the electric vehicle charging device.

FIG. 2 illustrates a state in which the charging connector 200 is separated from the electric vehicle charging device 10 illustrated in FIG. 1. FIG. 3 illustrates a state in which the holder 300 is separated from the electric vehicle charging device 10 illustrated in FIG. 1. FIG. 4 illustrates a connector fixing part 340 separated from the constituent elements of the holder 300 illustrated in FIG. 3.

Because the constituent elements illustrated in FIGS. 2 to 4 are substantially identical to the constituent elements of the electric vehicle charging device 10 illustrated in FIG. 1, the constituent elements illustrated in FIGS. 2 to 4 will be described below with reference to FIG. 1 together, and a duplicate description will be omitted.

First, with reference to FIG. 2, the charging connector 200 of the electric vehicle charging device 10 can include a connector main body 210 having one side at which a charging robot coupling part 211 is provided, one or more charging protrusions 220 protruding from the connector main body 210, a latch 230 coupled to the connector main body 210 so that the latch 230 is positioned above the charging protrusion 220, and a cable coupling part 240 extending from the connector main body 210 and configured such that the cable (e.g., the cable 400 in FIG. 1) is coupled to the cable coupling part 240. For example, the connector main body 210 can include a panel or plate. In some cases, the connector main body 210 can have a circular shape.

The charging robot coupling part 211 can be provided at one side of the connector main body 210. The charging robot coupling part 211 can be a constituent element to which at least a part of an electric vehicle charging robot (e.g., an automatic charging device) is coupled to grasp the charging connector 200 in an automatic charging system. For example, the charging robot can be coupled to the charging robot coupling part 211, such that the charging robot can grasp the charging connector 200 and connect the charging connector 200 to the electric vehicle.

In particular, the electric vehicle charging device 10 can be applied to an electric vehicle automatic charging system equipped with the automatic charging device (e.g., charging robot 20). In this case, the holder 300 can maintain the state in which the charging connector 200 is mounted at a predetermined position in the state in which the holder 300 prevents the charging connector 200 from rotating. Therefore, it is possible to stably perform the repetitive operations of the charging robot that grasps and mounts the charging connector 200.

The charging protrusion 220 can protrude from a part of the connector main body 210. The charging protrusion 220 can be connected to the charging terminal provided in the electric vehicle to charge the electric vehicle. The charging protrusion 220 can have terminals configured to be connected to the charging terminal of the electric vehicle. In some implementations, the charging protrusions 220 can be provided as two charging protrusions 220. One of the charging protrusions 220 can be a fast charging protrusion, and the other of the charging protrusions 220 can be a slow charging protrusion, but this is an example. The type of charging protrusion 220 and/or the number of charging protrusions 220 is not specifically limited. In a state in which the charging protrusion 220 is disposed to be directed toward the electric vehicle or the holder 300, the charging connector 200 can be moved and connected to the electric vehicle or mounted in the holder 300.

The latch 230 can be coupled to one side of the connector main body 210 from which the charging protrusion 220 protrudes, and the latch 230 can be positioned above the charging protrusion 220. The latch 230 can be a locking device configured to prevent a withdrawal of the charging connector 200 in case that the charging connector 200 is mounted in the holder 300. One end of the latch 230 can be coupled to the connector main body 210, and the other end of the latch 230 can be provided to be movable in the upward/downward direction. In this case, the other end of the latch 230 refers to an end provided in a direction in which the charging protrusion 220 is directed.

The latch 230 can be provided such that a restoring force for moving the other end of the latch 230 downward is applied in case that the other end of the latch 230 is moved upward. That is, the latch 230 can be provided such that the other end of the latch 230 is moved downward again and returned to an original state when an external force is eliminated in a state in which the other end of the latch 230 is moved upward by the external force.

The cable coupling part 240 can extend from a part of the connector main body 210 and configured such that the cable 400 is coupled to the cable coupling part 240. At least a part of the cable 400 can extend to the inside of the cable coupling part 240, and the extending cable 400 can pass through the inside of the connector main body 210 and be connected to the terminal of the charging protrusion 220. The cable coupling part 240 can extend by a predetermined length. The cable coupling part 240 can be a part grasped by a user when the user moves the charging connector 200 in case that the user manually charges the electric vehicle.

Next, with reference to FIGS. 3 and 4, the holder 300 of the electric vehicle charging device 10 can include a support 310, a slide 320 coupled to the support 310 and configured to be slidable in an upward/downward direction H, an elastic part 330 configured to elastically connect the slide 320 and the support 310 in the upward/downward direction H, the connector fixing part 340 coupled to a side of the support 310 based on a direction opposite to a reference direction D, and a connector seating part 350 coupled to the side of the support 310 based on the direction opposite to the reference direction D and configured to surround a part of the connector fixing part 340.

In this case, the reference direction D refers to a direction in which the charging connector 200 is inserted with respect to the holder 300. That is, the charging connector 200 can be inserted into the holder 300 in the reference direction D or withdrawn in the direction opposite to the reference direction D. In addition, the upward/downward direction H in which the slide 320 moves can be perpendicular to the reference direction D.

In the specification of the present application, for convenience of description, the direction in which the slide 320 moves is defined as the upward/downward direction based on the drawings. In some implementations, the direction can vary depending on the arrangement or installation of the holder 300. The holder 300 may not need to be installed on the main body 100 so that the movement direction of the slide 320 can be the upward/downward direction H.

The support 310 can be a base structure to which other constituent elements of the holder 300 are coupled. The support 310 can be coupled to the main body 100 of the electric vehicle charging device 10. For example, one surface of the support 310 based on the reference direction D can be fixed to the main body 100. The support 310 can be provided such that the slide 320, the elastic part 330, the connector fixing part 340, and the connector seating part 350 are coupled to the support 310.

The slide 320 can be coupled to the support 310 and configured to be slidable in the upward/downward direction H. For example, a slide groove 325 can be provided in the slide 320, a slide protrusion 311, which extends in the upward/downward direction H while corresponding to the slide groove 325, can be provided on the support 310, and the slide protrusion 311 can be inserted into the slide groove 325.

The slide 320 can include a slide body 321 coupled to the support 310, one or more first rollers 322 coupled to the slide body 321 and configured to be rotatable about a first rotation axis R1, one or more second rollers 323 coupled to the slide body 321 and configured to be rotatable about a second rotation axis R2, and a third roller 324 coupled to the slide body 321 and configured to be rotatable about a third rotation axis R3.

The slide body 321 can have the slide groove 325 into which the slide protrusion of the support 310 is inserted, such that the slide body 321 can be movably coupled to the support 310. The support 310 can be coupled to an end of the slide body 321 based on the reference direction D and configured to be movable upward or downward, and the third roller 324 can be coupled to an end of the slide body 321 based on the direction opposite to the reference direction D and configured to be rotatable.

The slide body 321 can include a base portion 321a, an extension portion 321b extending from the base portion 321a in the reference direction D and having the slide groove, first roller coupling portions 321c extending downward from one side (e.g., a right side on the basis of the drawings) of the base portion 321a, second roller coupling portions 321d extending downward from the other side (e.g., a left side based on the drawings) of the base portion 321a, and a third roller coupling portion 321e extending from the base portion 321a in the direction opposite to the reference direction D and coupled to the third roller 324.

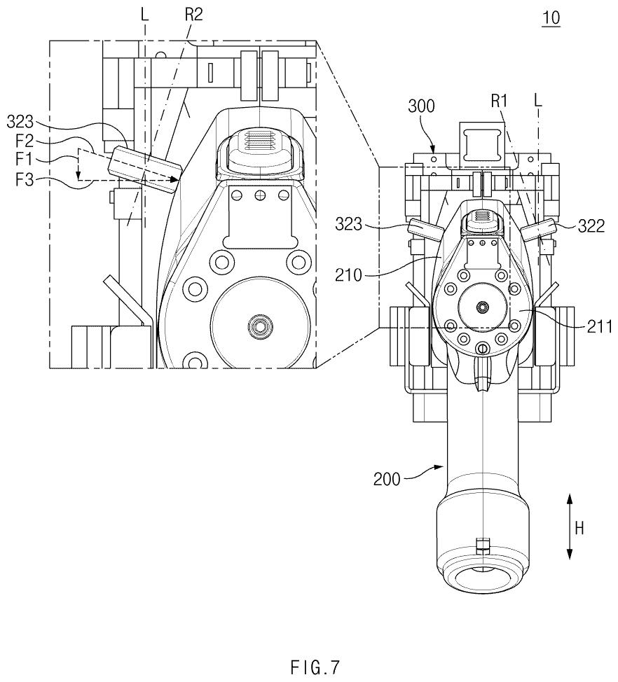

The first roller 322 can be coupled to one side (e.g., a right side based on the drawings) of the slide body 321 and configured to be rotatable about the first rotation axis R1. For example, the first roller 322 can be coupled to the first roller coupling portion 321c of the slide body 321. The first rotation axis R1 can be inclined to define a predetermined angle with respect to the movement direction (i.e., the upward/downward direction) of the slide 320. For example, when an imaginary straight line (e.g., an imaginary straight line L in FIG. 7), which penetrates the first roller 322 in the upward/downward direction H, is defined, the first rotation axis R1 can be inclined to define a predetermined angle with respect to the imaginary straight line in the leftward/rightward direction. The first rollers 322 can be configured as two first rollers 322. In some implementations, the number of first rollers 322 is not limited to two.

The second roller 323 can be coupled to the other side (e.g., a left side based on the drawings) of the slide body 321 so that the second roller 323 and the first roller 322 are symmetric. The second roller 323 can be rotatable about the second rotation axis R2. For example, the second roller 323 can be coupled to the second roller coupling portion 321d of the slide body 321. The second rotation axis R2 can be inclined to define a predetermined angle with respect to the movement direction of the slide 320 (i.e., the upward/downward direction H) so that the second rotation axis R2 and the first rotation axis R1 are symmetric vertically. The second rollers 323 can be provided as two second rollers 323. In some implementations, the number of second rollers 323 is not limited to two. The number of second rollers 323 can be variously changed within a range in which the second roller 323 and the first roller 322 are symmetric.

The first roller 322 and the second roller 323 can be coupled to the slide body 321 so as to be symmetric in the leftward/rightward direction with respect to a central axis of the slide body 321 parallel to the reference direction D and a central axis of the slide body 321 parallel to the upward/downward direction H. For example, when the slide 320 is viewed in the reference direction D, the first roller 322 and the second roller 323 can be disposed to be symmetric vertically. The first rotation axis R1 of the first roller 322 and the second rotation axis R2 of the second roller 323 can be provided to be symmetric. The first rotation axis R1 of the first roller 322 and the second rotation axis R2 of the second roller 323 can become close to each other in the upward direction and become distant from each other in the downward direction.

The first roller 322 and the second roller 323 can guide the movement of the holder 300 and the movement of the slide 320 while coming into contact with an outer surface of the charging connector 200 and rotating when the charging connector 200 is inserted into the holder 300 or withdrawn from the holder 300. In addition, in the state in which the charging connector 200 is mounted in the holder 300, the first roller 322 and the second roller 323 can press the charging connector 200 downward while being tightly attached to the charging connector 200 by a restoring force of the elastic part 330 to be described below.

The first roller 322 and the second roller 323 can be made of an elastic material (e.g., urethane or rubber) having predetermined hardness so that the first roller 322 and the second roller 323 can be tightly attached to the outer surface of the charging connector 200 but may not be stretched or contracted at a predetermined level or higher. This is to prevent a force for fixing the charging connector 200 from being lost as the first roller 322 and the second roller 323 are excessively stretched or contracted when the charging connector 200 is mounted.

The third roller 324 can be coupled to the end of the slide body 321 based on the direction opposite to the reference direction D and configured to be rotatable about the third rotation axis R3 perpendicular to the upward/downward direction H and the reference direction D. For example, the third roller 324 can be coupled to the third roller coupling portion 321e of the slide body 321. When the slide 320 is viewed in the reference direction D, the third roller 324 can be positioned between the first rotation axis R1 of the first roller 322 and the first rotation axis R1 of the second roller 323 and positioned above the first roller 322 and the second roller 323.

The third roller 324 can guide the movement of the holder 300 and the movement of the slide 320 while coming into contact with the outer surface of the charging connector 200 and rotating when the charging connector 200 is inserted into the holder 300 or withdrawn from the holder 300.

The elastic part 330 can be provided to connect the support 310 and the slide 320 in the upward/downward direction H and provide an elastic force (or a restoring force) in accordance with the movement of the slide 320 in the upward/downward direction H. A lower end of the elastic part 330 can be coupled to the support 310, and an upper end of the elastic part 330 can be coupled to the extension portion 321b of the slide 320.

The lower end of the elastic part 330 is coupled and fixed to the support 310, and the upper end of the elastic part 330 is coupled to the slide 320 and moved in the upward/downward direction. Therefore, when the slide 320 moves upward, the elastic part 330 can be stretched by a predetermined length. When the slide 320 moves downward, the elastic part 330 can be compressed again by the stretched length and restored to an original state. That is, in case that the slide 320 moves upward, the elastic part 330 can be stretched by a predetermined length and generate an elastic force for pulling the slide 320 downward. The elastic part 330 can include a spring (e.g., a tensile spring). The present disclosure is not limited thereto. For example, the elastic part 330 can be configured as a rubber cord, a rubber band, or the like.

A stopper 312 can be provided on the support 310 and restrict a downward movement of the slide 320. When the slide 320 is in contact with the stopper 312, the elastic part 330 can be in an original state in which no external force is applied, and no deformation occurs. When the slide 320 is spaced apart from the stopper 312 as the slide 320 moves upward, the elastic part 330 can be stretched from the original state and generate the restoring force for restoring the elastic part 330 to the original state. The restoring force can act as a force for pulling the slide 320 downward.

The charging protrusions 220 of the charging connector 200 can be inserted into the connector fixing part 340. The latch 230 of the charging connector 200 can be fixed by being caught by the connector fixing part 340.

The connector fixing part 340 can include a plate 341 coupled to the support 310, a socket 342 protruding from the plate 341 and having insertion grooves 343 formed in shapes corresponding to the charging protrusions 220, and a fastening member 344 formed above the socket 342 and configured such that the latch 230 is fastened to the fastening member 344.

The fastening member 344 can be provided at an upper side of the socket 342 while corresponding to the position of the latch 230 provided above the charging protrusion 220. The fastening member 344 can include a fixing protrusion 345 protruding upward so that the latch 230 is fixed by being caught by the fixing protrusion 345, and two guide protrusions 346 protruding from two opposite sides of the fixing protrusion 345 and extending in the reference direction D.

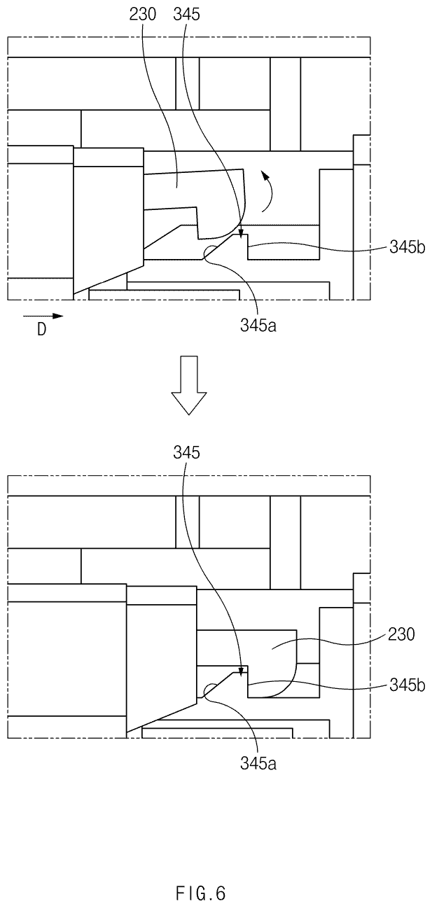

A surface (e.g., a vertical surface 345b in FIG. 6) of the fixing protrusion 345 directed in the reference direction D can be parallel to the upward/downward direction H (i.e., perpendicular to an upper surface of the socket 342), and a surface (e.g., an inclined surface 345a in FIG. 6) of the fixing protrusion 345 directed in the direction opposite to the reference direction D can be inclined. For example, the surface of the fixing protrusion 345 directed in the reference direction D can extend vertically so that the latch 230 can be fixed by being caught by the surface of the fixing protrusion 345. In addition, the surface of the fixing protrusion 345 directed in the direction opposite to the reference direction D can extend to be inclined downward in the direction opposite to the reference direction D so that a part of the latch 230, which moves in the reference direction D, is moved upward.

The two guide protrusions 346 can be disposed to face each other with the fixing protrusion 345 interposed therebetween. The two guide protrusions 346 can guide the movement of the latch 230 to be fastened to the fastening member 344. That is, the latch 230 can be caught and fixed by the fixing protrusion 345 while moving in the reference direction D along a route defined by a space between the two guide protrusions 346.

The connector seating part 350 can be provided such that the connector main body 210 and the cable coupling part 240 of the charging connector 200 are at least partially seated in the connector seating part 350. The connector seating part 350 can be coupled to the support 310, have a predetermined accommodation space formed therein, and have a shape opened upward.

The connector seating part 350 can be coupled to the support 310 so that at least a part of the connector fixing part 340 is disposed in the accommodation space. Therefore, as illustrated in FIG. 1, in the state in which the charging protrusion 220 of the charging connector 200 is inserted into the connector fixing part 340, the connector main body 210 and the cable coupling part 240 can be at least partially seated in the connector seating part 350 in the accommodation space of the connector seating part 350.

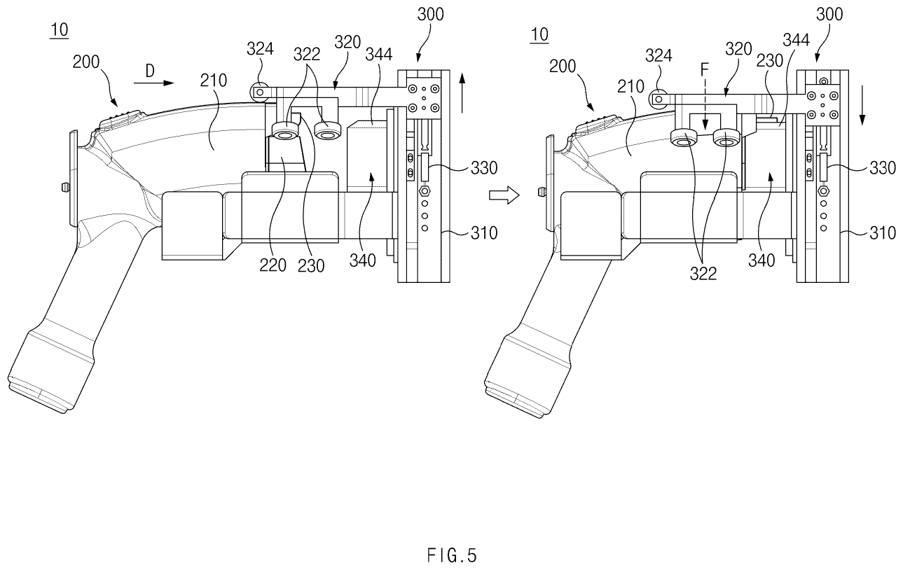

Hereinafter, an operation of mounting the charging connector 200 in the holder 300 will be described with reference to FIGS. 5 and 6.

FIG. 5 is a view illustrating the operation of mounting the charging connector in the holder in the electric vehicle charging device. FIG. 6 is a view illustrating an operation of fixing the latch of the charging connector to the connector fixing part during the operation illustrated in FIG. 5.

FIGS. 5 and 6 are views illustrating the operation of mounting the charging connector 200 in the holder 300 in the electric vehicle charging device 10 described above with reference to FIGS. 1 to 4. Hereinafter, FIGS. 5 and 6 will be described with reference to FIGS. 1 to 4 together, and a duplicate description will be omitted.

With reference to FIGS. 5 and 6, the charging protrusion 220 of the charging connector 200 can be moved toward the holder 300 in the reference direction D and mounted in the holder 300.

Specifically, the first roller 322, the second roller (e.g., the second roller 323 in FIG. 3), and the third roller 324 are rotated along an outer surface of the connector main body 210 when the charging connector 200 is mounted by being inserted into the holder 300 in the reference direction D, and as a result, the slide 320 is raised by a predetermined length by the connector main body 210. For example, the first roller 322 and the second roller 323 rotate while coming into contact with left and right surfaces of the connector main body 210, and the third roller 324 rotates while coming into contact with an upper surface of the connector main body 210. That is, the first roller 322, the second roller 323, and the third roller 324 are tightly attached to the connector main body 210 and rotated, such that the slide 320 is raised while corresponding to the insertion of the connector main body 210.

When the slide 320 is raised, a force for pulling the slide 320 downward is applied by a restoring force generated while the elastic part 330 is stretched. Therefore, the slide 320 presses (F) the charging connector 200 downward. For example, the holder 300 can maintain the state in which the slide 320 is in contact with the stopper (e.g., the stopper 312 in FIG. 3) provided on the support 310 before the charging connector 200 is inserted. As the charging connector 200 is inserted, the slide 320 can be raised while being moved away from the stopper 312.

When the charging connector 200 is moved in the reference direction D until the charging protrusion 220 is inserted into the connector fixing part 340, the latch 230 is fixed by being caught by the fixing protrusion 345, such that the charging connector 200 is completely mounted. Specifically, as illustrated in FIG. 6, the end of the latch 230 based on the reference direction D is raised along the inclined surface 345a of the fixing protrusion 345 by the movement of the charging connector 200, and then the end of the latch 230 is lowered while passing over the inclined surface 345a and comes into contact with the vertical surface 345b of the fixing protrusion 345.

A state of the holder 300 in which the charging connector 200 is separated from the holder 300 is defined as a basic state (e.g., a state of the holder 300 illustrated in FIG. 3), and a state of the holder 300 in which the charging protrusion 220 is inserted into the connector fixing part 340 (particularly, the socket 342 in FIG. 4) and the latch 230 is caught and fixed by the fastening member 344 is defined as a mounted state (e.g., a state of the holder 300 illustrated at the right side in FIG. 5). In this case, the slide 320 is raised by a predetermined length as the holder 300 switches from the basic state to the mounted state. In the mounted state, the slide 320 is spaced apart from the stopper 312 of the support 310, and the elastic part 330 is stretched by a predetermined length from the original state and applies a restoring force.

In the mounted state, the slide 320 presses downward the charging connector 200 mounted in the holder 300 by the restoring force of the elastic part 330, and the latch 230 of the charging connector 200 is fixed to the fastening member 344 of the holder 300, such that the rotation and inadvertent movement of the charging connector 200 in the holder 300 can be prevented. In particular, the first roller 322 and the second roller 323 apply forces to the charging connector 200 while being tightly attached to the outer surface of the charging connector 200 by the restoring force of the elastic part 330 applied downward to the slide 320.

In some implementations, the slide 320, which has been raised by a predetermined length when the charging connector 200 has been inserted, can be lowered in the mounted state by a length shorter than the length by which the slide 320 has been raised when the charging connector 200 has been inserted. This process is performed because an external appearance of the connector main body 210 corresponds to the shape inclined downward in the direction opposite to the reference direction D. The present disclosure is not limited to the illustrated implementations.

In some implementations, the holder 300 and the charging connector 200 can be implemented in various shapes within a range in which in the mounted state, the restoring force of the elastic part 330 can be applied to the slide 320, and the charging connector 200 can be pressed downward by the restoring force of the elastic part 330.

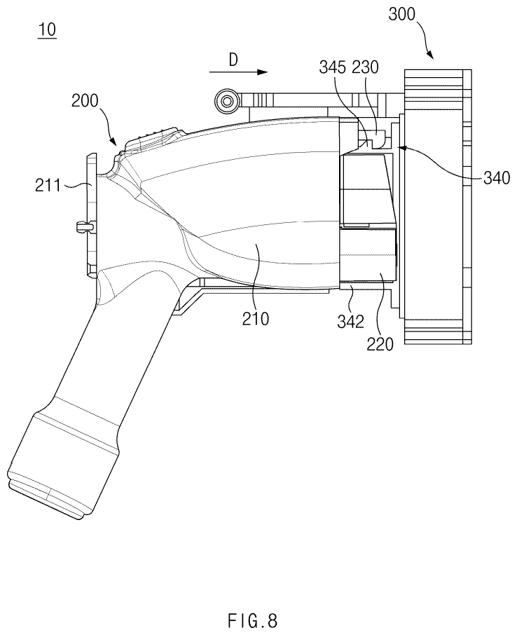

Hereinafter, a mechanism for fixing the charging connector 200 at a predetermined position while preventing a rotation of the charging connector 200 in the mounted state in which the charging connector 200 is mounted in the holder 300 will be described with reference to FIGS. 7 and 8.

FIG. 7 is a view illustrating a state in which the charging connector is mounted in the holder in the electric vehicle charging device. FIG. 8 is a view illustrating a state in which the charging connector is mounted in the holder in the electric vehicle charging device.

FIG. 7 illustrates the state in which the charging connector 200 is mounted in the holder 300 when viewed from the front side, and FIG. 8 illustrates the state in which the charging connector 200 is mounted in the holder 300 when viewed from the lateral side.

FIGS. 7 and 8 are views for explaining a force applied to the charging connector 200 to fix the charging connector 200 in the state in which the charging connector 200 is mounted in the holder 300. Hereinafter, FIGS. 7 and 8 will be described with reference to FIGS. 1 to 4 together, and a duplicate description will be omitted.

With reference to FIG. 7, in the state in which the charging connector 200 is mounted in the holder 300, a first pressing force F1, which is applied downward, is applied to the connector main body 210 of the charging connector 200 by the restoring force of the elastic part (e.g., the elastic part 330 in FIG. 3), and a second pressing force F2, which is applied in the direction perpendicular to the first rotation axis R1 and the second rotation axis R2, is applied to the connector main body 210 of the charging connector 200 by the tight attachment of the first roller 322 and the second roller 323. The second pressing force F2 can be divided into the first pressing force F1, which is applied in the downward direction, and a third pressing force F3 applied in the leftward/rightward direction.

The first roller 322 and the second roller 323 can apply the forces to the charging connector 200 in the inclined direction by being tightly attached to the charging connector 200 in the state in which the first roller 322 and the second roller 323 are disposed to be inclined. As illustrated in FIG. 7, the imaginary straight line L, which penetrates the first roller 322 and the second roller 323 in the upward/downward direction H when the holder 300 is viewed in the reference direction D, can be defined. The first roller 322 can be disposed to be inclined so that the first rotation axis R1 is inclined at a predetermined angle in the leftward/rightward direction with respect to the imaginary straight line L. The second roller 323 can be disposed to be inclined so that the second rotation axis R2 is inclined at a predetermined angle in the leftward/rightward direction with respect to the imaginary straight line L, and the second rotation axis R2 and the first rotation axis R1 are symmetric vertically.

In addition, with reference to FIG. 8, in the state in which the charging connector 200 is mounted in the holder 300, the charging protrusion 220 of the charging connector 200 is inserted into the socket 342 of the connector fixing part 340, and the connector main body 210 comes into contact with the socket 342, such that the movement of the charging connector 200 in the reference direction D is restricted. In addition, in the state in which the charging connector 200 is mounted in the holder 300, the latch 230 of the charging connector 200 is fixed by being caught by the fixing protrusion 345 of the connector fixing part 340, such that the movement of the charging connector 200 in the direction opposite to the reference direction D is restricted.

As described above, the charging connector 200 is fixed at a predetermined position while being prevented from being rotated and inadvertently moved in the state in which the charging connector 200 is mounted in the holder 300, such that the charging connector 200 can be positioned at the predetermined position even though a load is applied to the charging connector 200 during the process of coupling the charging robot coupling part 211 to allow the charging robot to grasp the charging connector 200. Therefore, the charging robot can be stably coupled and separated.

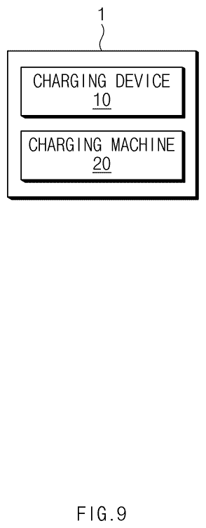

FIG. 9 is a block diagram of the electric vehicle automatic charging system including the electric vehicle charging device.

FIG. 9 is a configuration view illustrating an electric vehicle automatic charging system 1 including the electric vehicle charging device 10 described with reference to FIGS. 1 to 8.

With reference to FIG. 9, the electric vehicle automatic charging system 1 can include the charging device 10 and a charging robot 20. Because the charging device 10 can be referred to as the charging device 10 in FIGS. 1 to 8, a duplicate description will be omitted.

The electric vehicle automatic charging system 1 can be configured such that the charging robot 20 grasps the charging connector 200 of the charging device 10 and connects the charging connector 200 to the electric vehicle, thereby automatically charging the electric vehicle.

Specifically, the charging robot 20 is connected to the charging robot coupling part 211 of the charging connector 200, such that the charging robot 20 can grasp the charging connector 200. For example, the charging robot 20 can move to an electric vehicle to be charged and connect the charging protrusion 220 of the charging connector 200 to the charging terminal of the electric vehicle. In some examples, with the structure of the holder 300, the charging connector 200 can be mounted in the holder 300 by the charging robot 20, or the charging connector 200 can be stably grasped and disposed again by the charging robot 20 when the charging connector 200 is separated from the holder 300. Therefore, it can be possible to provide the stable automatic charging system. For instance, the charging robot 20 can be a machine configured to move independently or under human control (e.g., walking or rolling on wheels) and to perform actions such as grasping and moving objects.

The above description is simply given to illustratively describe the technical spirit of the present disclosure, and those skilled in the art to which the present disclosure pertains will appreciate that various changes and modifications are possible without departing from the essential characteristic of the present disclosure. Therefore, the embodiments disclosed in the present disclosure are provided for illustrative purposes only but are not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

What is claimed is:

1. An electric vehicle charging device comprising:
a charging connector configured to be connected to a charging terminal of an electric vehicle; and
a holder configured to mount the charging connector,
wherein the holder comprises:
a support,
a slide coupled to the support and configured to move relative to the support in an upward/downward direction, and
an elastic part that connects the slide to the support in the upward/downward direction,
wherein the slide comprises a first roller and a second roller that are configured to, based on the charging connector being inserted to or withdrawn from the holder, contact an outer surface of the charging connector and rotate along the outer surface of the charging connector, and
wherein the first and second rollers are configured to be positioned at symmetric positions with respect to the charging connector.

2. The electric vehicle charging device of claim 1, wherein the first roller is configured to rotate about a first rotation axis inclined by a first predetermined angle with respect to the upward/downward direction, and
wherein the second roller is configured to rotate about a second rotation axis inclined by a second predetermined angle with respect to the upward/downward direction.

3. The electric vehicle charging device of claim 2, wherein the slide further comprises a slide body to which the first and second rollers are rotatably coupled in a state in which the first and second rollers are inclined with respect to the upward/downward direction, and
wherein the first and second rotation axes become closer to each other as the first and second rotation axes extend upward toward the slide body.

4. The electric vehicle charging device of claim 3, wherein the slide further comprises a third roller coupled to the slide body and configured to rotate about a third rotation axis, the third rotation axis extending in a leftward/rightward direction orthogonal to the upward/downward direction.

5. The electric vehicle charging device of claim 4, wherein the third roller is positioned above the first roller and the second roller.

6. The electric vehicle charging device of claim 3, further comprising a main body coupled to the holder and configured to control operation of the electric vehicle charging device,
wherein the holder is configured to receive the charging connector along a reference direction, and
wherein a surface of the support is fixed to the main body in the reference direction.

7. The electric vehicle charging device of claim 6, wherein the slide body comprises:
a base portion;
a first roller coupling portion that extends downward from a first side of the base portion;
a second roller coupling portion that extends downward from a second side of the base portion; and
a third roller coupling portion that is disposed between the first roller coupling portion and the second roller coupling portion and that extends from the base portion in a direction opposite to the reference direction.

8. The electric vehicle charging device of claim 6, wherein the first predetermined angle is defined between the first rotation axis and a first imaginary straight line extending through the first roller in the upward/downward direction,
wherein the second predetermined angle is defined between the second rotation axis and a second imaginary straight line passing through the second roller in the upward/downward direction, and
wherein the first and second rotation axes are symmetric with respect to a plane extending through the holder in the upward/downward direction.

9. The electric vehicle charging device of claim 1, wherein the support comprises a stopper configured to come into contact with the slide and to restrict a downward movement of the slide.

10. The electric vehicle charging device of claim 1, wherein the support further comprises a slide protrusion that extends in the upward/downward direction and is configured to movably couple the slide to the support, and
wherein the slide defines a slide groove configured to receive the slide protrusion.

11. The electric vehicle charging device of claim 1, wherein the elastic part is configured to:
based on the slide being raised by charging connector, generate restoring force while being stretched by a predetermined length; and
apply the restoring force to the slider to thereby provide pulling force to the slide downward.

12. The electric vehicle charging device of claim 11, wherein the elastic part comprises a spring.

13. The electric vehicle charging device of claim 1, wherein the charging connector comprises:
a connector main body comprising a charging robot coupling part;
one or more charging protrusions that protrude from the connector main body; and
a latch coupled to the connector main body and positioned above the one or more charging protrusions.

14. The electric vehicle charging device of claim 13, wherein the holder further comprises a connector fixing part comprising:
a socket configured to receive the one or more charging protrusions, and
a fixing protrusion that protrudes from an upper side of the socket and is configured to catch and couple to the latch.

15. The electric vehicle charging device of claim 14, wherein the latch is configured to, based on the charging connector being mounted to the holder, be fixed to the fixing protrusion by being caught by the fixing protrusion, and
wherein the first and second rollers are configured to press the charging connector by restoring force of the elastic part.

16. An electric vehicle automatic charging system comprising:
an electric vehicle charging device comprising a charging connector configured to be connected to a charging terminal of an electric vehicle; and
a charging machine configured to grasp the charging connector, the charging machine being configured to at least one of (i) connect the charging connector to the charging terminal of the electric vehicle or (ii) separate the charging connector from the charging terminal of the electric vehicle,
wherein the electric vehicle charging device further comprises a holder configured to mount the charging connector, the holder comprising:
a support,
a slide coupled to the support and configured to move relative to the support in an upward/downward direction, and
an elastic part that connects the slide to the support in the upward/downward direction,
wherein the slide comprises a first roller and a second roller that are configured to, based on the charging connector being inserted to or withdrawn from the holder, contact an outer surface of the charging connector and rotate along the outer surface of the charging connector, and
wherein the first and second rollers are configured to be positioned at symmetric positions with respect to the charging connector.

17. The electric vehicle automatic charging system of claim 16, wherein the electric vehicle charging device further comprises a main body coupled to the holder and configured to control operation of the electric vehicle charging device.
